(19) United States
(12) Patent Application Publication
(10) Pub. No.: US 2019/0143221 A1
(43) Pub. Date: May 16, 2019

(54) GENERATION AND CUSTOMIZATION OF PERSONALIZED AVATARS

(71) Applicant: Sony Interactive Entertainment America LLC, San Mateo, CA (US)

(72) Inventors: Sreelata Santhosh, San Mateo, CA (US); Arthur Salazar, San Mateo, CA (US)

(21) Appl. No.: 15/813,754

(22) Filed: Nov. 15, 2017

(51) Int. Cl. A63F 13/79; A63F 13/655; G06K 9/00

(52) U.S. Cl. CPC A63F 13/79; A63F 2300/5553; G06K 9/00261; A63F 13/655

(57) ABSTRACT

The generation and customization of personalized avatars is based on matching a user's image to computer game avatars by identifying which game avatar the user is closest to resembling. A database of avatar images from various games is established and updated as game publishers upload new avatars to it, refreshing the database as new games are released. Users upload their own picture following preset guidelines and image fingerprinting is used, e.g., using perceptual hashing techniques, to detect the closest avatar in similarity to the user. Alternatively, an image of the user can be combined with an image of an avatar to render a morphed avatar image.

### FIELD

The present application relates to technically inventive, non-routine solutions that are necessarily rooted in computer technology and that produce concrete technical improvements.

### BACKGROUND

As understood herein, in computer games, players may be assigned “avatars” typically represented by an image.

### SUMMARY

As further understood herein, it may be desirable to enhance the gaming experience by allowing players to customize their avatars in personal ways.

Accordingly, a device includes at least one computer memory that is not a transitory signal and that in turn includes instructions executable by at least one processor to receive at least one image of at least one human user. The instructions are executable to execute a perceptual hash on the image to render a hash result, select from a data store of computer game avatars a closest avatar based at least in part on a hash associated with the closest avatar being a closest match to the hash result, and return the closest avatar to a computer game device as an avatar associated with the human user.

In some examples, the perceptual hash is a p-hash. In example implementations the instructions may be executable to present on at least one display a prompt for the human user to enable the closest avatar to represent a character in a computer game, and responsive to a selection to enable the closest avatar to represent a character in a computer game, identify at least one transaction for the user to remit remuneration.

If desired, the instructions can be executable to present on at least one display a prompt for the human user to input an image of the human user having a delineated characteristic for use in comparing to the avatars in the data store. The delineated characteristic may be, e.g., a full-face view or a face and body view. The data store may be updated with avatars of new computer games pursuant to the new computers games being published.

In another aspect, an apparatus includes at least one computer storage with instructions executable by at least one processor, and at least one processor configured to access the instructions for receiving at least one image of at least one human user. The instructions are executable for blending the image of the user with an image of an avatar of a computer game to render a morphed avatar. The instructions are further executable for returning the morphed avatar to a computer game device as an avatar associated with the human user.

In another aspect, a method includes receiving at least one image of at least one human, and based at least in part on the image, returning an avatar for a computer game.

The details of the present application, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system including an example in accordance with present principles;

FIG. 2 is schematic diagram of an example avatar database;

FIGS. 3-5 is screen shots of example user interfaces (UI) for personalizing avatars consistent with present principles;

FIG. 6 is a flow chart of example logic for selecting a “closest” avatar to the player's appearance consistent with present principles; and

FIG. 7 is a flow chart of alternate logic for rendering a “morphed” avatar that blends a player's image with an avatar image, consistent with present principles.

### DETAILED DESCRIPTION

This disclosure relates generally to computer ecosystems including aspects of consumer electronics (CE) device networks such as but not limited to distributed computer game networks.

A system herein may include server and client components, connected over a network such that data may be exchanged between the client and server components. The client components may include one or more computing devices including game consoles such as but not limited to Sony PlayStation™ and Microsoft Xbox™, portable televisions (e.g. smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Orbis or Linux operating systems, operating systems from Microsoft, or a Unix operating system, or operating systems produced by Apple Computer or Google. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may include one or more processors executing instructions that configure the servers to receive and transmit data over a network such as the Internet. Or, a client and server can be connected over a local intranet or a virtual private network. A server or controller may be instantiated by a game console such as a Sony PlayStation, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members.

As used herein, instructions refer to computer-implemented steps for processing information in the system. Instructions can be implemented in software, firmware or hardware and include any type of programmed step undertaken by components of the system.

A processor may be any conventional general-purpose single- or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library.

Present principles described herein can be implemented as hardware, software, firmware, or combinations thereof; hence, illustrative components, blocks, modules, circuits, and steps are set forth in terms of their functionality.

Further to what has been alluded to above, logical blocks, modules, and circuits described below can be implemented or performed with a general-purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may be embodied in a non-transitory device such as a CD ROM or Flash drive. The software code instructions may alternatively be embodied in a transitory arrangement such as a radio or optical signal, or via a download over the internet.

The functions and methods described below, when implemented in software, can be written in an appropriate language such as but not limited to Java, C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires. Such connections may include wireless communication connections including infrared and radio.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B. C”) includes systems that have A alone, B alone, C alone, A and B together, A and C together, B and C together, and/or A, B. and C together, etc.

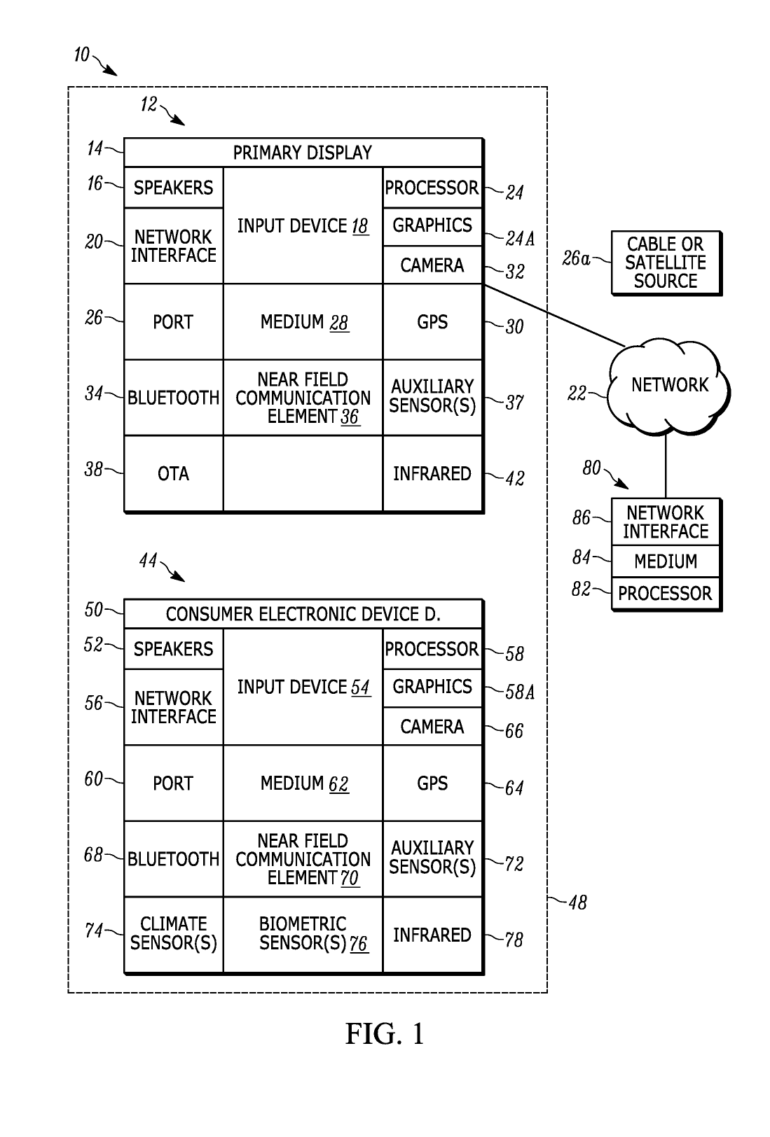

Now specifically referring to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a computer game console system with display or an Internet-enabled TV with a TV tuner (equivalently, set top box controlling a TV). However, the AVD 12 alternatively may be an appliance or household item. e.g. computerized Internet enabled refrigerator, washer, or dryer. The AVD 12 alternatively may also be a computerized Internet enabled (“smart”) telephone, a tablet computer, a notebook computer, a wearable computerized device such as e.g. computerized Internet-enabled watch, a computerized Internet-enabled bracelet, other computerized Internet-enabled devices, a computerized Internet-enabled music player, computerized Internet-enabled head phones, a computerized Internet-enabled implantable device such as an implantable skin device, etc. Regardless, it is to be understood that the AVD 12 is configured to undertake present principles (e.g. communicate with other CE devices to undertake present principles, execute the logic described herein, and perform any other functions and/or operations described herein).

Accordingly, to undertake such principles the AVD 12 can be established by some or all of the components shown in FIG. 1. For example, the AVD 12 can include one or more displays 14 that may be implemented by a high definition or ultra-high definition “4K” or higher flat screen and that may be touch-enabled for receiving user input signals via touches on the display. The AVD 12 may include one or more speakers 16 for outputting audio in accordance with present principles, and at least one additional input device 18 such as e.g. an audio receiver/microphone for e.g. entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as e.g. controlling the display 14 to present images thereon and receiving input therefrom. Furthermore, note the network interface 20 may be, e.g., a wired or wireless modem or router, or other appropriate interface such as, e.g., a wireless telephony transceiver, or Wi-Fi transceiver as mentioned above, etc.

In addition to the foregoing, the AVD 12 may also include one or more input ports 26 such as, e.g., a high definition multimedia interface (HDMI) port or a USB port to physically connect (e.g. using a wired connection) to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be, e.g., a separate or integrated set top box, or a satellite receiver. Or, the source 26a may be a game console or disk player containing content such as computer game software and databases. The source 26a when implemented as a game console may include some or all of the components described below in relation to the CE device 44.

The AVD 12 may further include one or more computer memories 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media. Also in some embodiments, the AVD 12 can include a position or location receiver such as but not limited to a cellphone receiver, GPS receiver and/or altimeter 30 that is configured to e.g. receive geographic position information from at least one satellite or cellphone tower and provide the information to the processor 24 and/or determine an altitude at which the AVD 12 is disposed in conjunction with the processor 24. However, it is to be understood that that another suitable position receiver other than a cellphone receiver, GPS receiver and/or altimeter may be used in accordance with present principles to e.g. determine the location of the AVD 12 in e.g. all three dimensions.

Continuing the description of the AVD 12, in some embodiments the AVD 12 may include one or more cameras 32 that may be, e.g., a thermal imaging camera, a digital camera such as a webcam, and/or a camera integrated into the AVD 12 and controllable by the processor 24 to gather pictures/images and/or video in accordance with present principles. Also included on the AVD 12 may be a Bluetooth transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 37 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command), etc.) providing input to the processor 24. The AVD 12 may include an over-the-air TV broadcast port 38 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12.

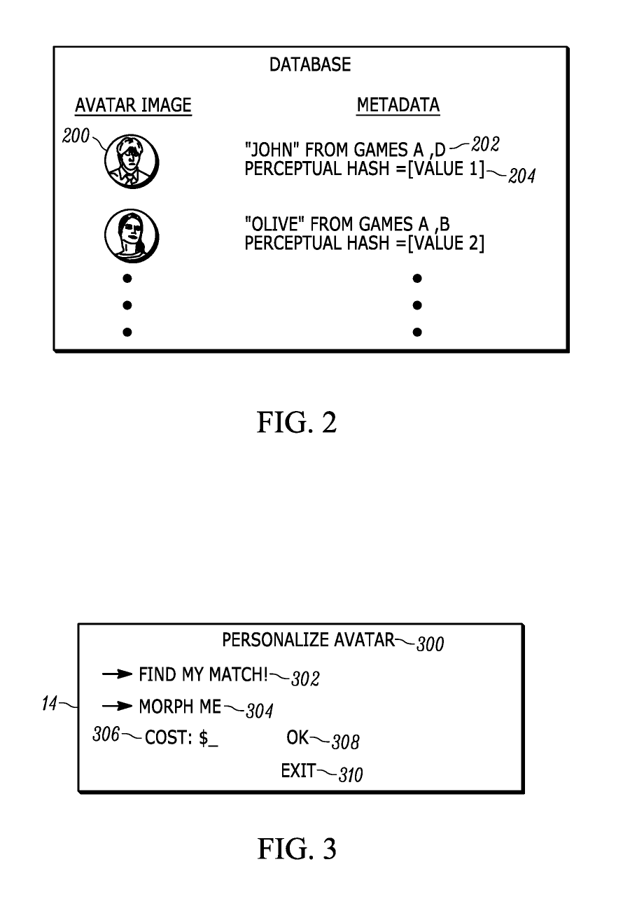

Still referring to FIG. 1, in addition to the AVD 12, the system 10 may include one or more other CE device types. In one example, a first CE device 44 may be used to control the display via commands sent through the below-described server while a second CE device such as the source 26a may include similar components as the first CE device 44 and hence will not be discussed in detail. Fewer or greater devices may be used. As alluded to above, a CE device may be implemented by a game console. Or, one or more of the CE devices may be implemented by a computer game headset such as the example headset 200 shown in FIG. 2.

In the example shown, to illustrate present principles all the devices are assumed to be members of an entertainment network in, e.g., a home, or at least to be present in proximity to each other in a location such as a house. However, for present principles are not limited to a particular location, illustrated by dashed lines 48, unless explicitly claimed otherwise.

The example non-limiting first CE device 44 may be established by any one of the above-mentioned devices, for example, a portable wireless laptop computer or notebook computer or game controller (also referred to as “console”), and accordingly may have one or more of the components described below. The second CE device 26a without limitation may be established by a video disk player such as a Blu-ray player, a game console, and the like. The first CE device 44 may be a remote control (RC) for, e.g., issuing AV play and pause commands to the AVD 12, or it may be a more sophisticated device such as a tablet computer, a game controller communicating via wired or wireless link with a game console implemented by the second CE device and controlling video game presentation on the AVD 12, a personal computer, a wireless telephone, etc.

Accordingly, the first CE device 44 may include one or more displays 50 that may be touch-enabled for receiving user input signals via touches on the display. The first CE device 44 may include one or more speakers 52 for outputting audio in accordance with present principles, and at least one additional input device 54 such as e.g. an audio receiver/microphone for e.g. entering audible commands to the first CE device 44 to control the device 44. The example first CE device 44 may also include one or more network interfaces 56 for communication over the network 22 under control of one or more CE device processors 58. Thus, the interface 56 may be, without limitation, a Wi-Fi transceiver, which is an example of a wireless computer network interface, including mesh network interfaces. It is to be understood that the processor 58 controls the first CE device 44 to undertake present principles, including the other elements of the first CE device 44 described herein such as a graphics processor 58a for controlling the display 50 to present images thereon and receiving input therefrom. Furthermore, note the network interface 56 may be, e.g., a wired or wireless modem or router, or other appropriate interface such as, e.g., a wireless telephony transceiver, or Wi-Fi transceiver as mentioned above, etc.

In addition to the foregoing, the first CE device 44 may also include one or more input ports 60 such as, e.g., a HDMI port or a USB port to physically connect (e.g. using a wired connection) to another CE device and/or a headphone port to connect headphones to the first CE device 44 for presentation of audio from the first CE device 44 to a user through the headphones. The first CE device 44 may further include one or more tangible computer readable storage medium 62 such as disk-based or solid-state storage. Also in some embodiments, the first CE device 44 can include a position or location receiver such as but not limited to a cellphone and/or GPS receiver and/or altimeter 64 that is configured to e.g. receive geographic position information from at least one satellite and/or cell tower, using triangulation, and provide the information to the CE device processor 58 and/or determine an altitude at which the first CE device 44 is disposed in conjunction with the CE device processor 58. However, it is to be understood that that another suitable position receiver other than a cellphone and/or GPS receiver and/or altimeter may be used in accordance with present principles to e.g. determine the location of the first CE device 44 in e.g. all three dimensions.

Continuing the description of the first CE device 44, in some embodiments the first CE device 44 may include one or more cameras 66 that may be, e.g., a thermal imaging camera, a digital camera such as a webcam, and/or a camera integrated into the first CE device 44 and controllable by the CE device processor 58 to gather pictures/images and/or video in accordance with present principles. Also included on the first CE device 44 may be a Bluetooth transceiver 68 and other Near Field Communication (NFC) element 70 for communication with other devices using Bluetooth and/or NFC technology, respectively. An example NFC element can be a radio frequency identification (RFID) element.

Further still, the first CE device 44 may include one or more auxiliary sensors 72 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command), etc.) providing input to the CE device processor 58. The first CE device 44 may include still other sensors such as e.g. one or more climate sensors 74 (e.g. barometers, humidity sensors, wind sensors, light sensors, temperature sensors, etc.) and/or one or more biometric sensors 76 providing input to the CE device processor 58. In addition to the foregoing, it is noted that in some embodiments the first CE device 44 may also include an infrared (IR) transmitter and/or IR receiver and/or IR transceiver 78 such as an IR data association (IRDA) device. A battery (not shown) may be provided for powering the first CE device 44. The CE device 44 may communicate with the AVD 12 through any of the above-described communication modes and related components.

CE devices may include some or all of the components shown for the CE device 44. CE devices may be powered by one or more batteries.

Now in reference to the afore-mentioned at least one server 80, it includes at least one server processor 82, at least one tangible computer readable storage medium 84 such as disk-based or solid-state storage, and at least one network interface 86 that, under control of the server processor 82, allows for communication with the other devices of FIG. 1 over the network 22, and indeed may facilitate communication between servers and client devices in accordance with present principles. Note that the network interface 86 may be, e.g., a wired or wireless modem or router, Wi-Fi transceiver, or other appropriate interface such as, e.g., a wireless telephony transceiver. Typically, the server 80 includes multiple processors in multiple computers referred to as “blades”.

Accordingly, in some embodiments the server 80 may be an Internet server or an entire server “farm”, and may include and perform “cloud” functions such that the devices of the system 10 may access a “cloud” environment via the server 80 in example embodiments for, e.g., network gaming applications. Or, the server 80 may be implemented by one or more game consoles or other computers in the same room as the other devices shown in FIG. 1 or nearby.

FIG. 2 illustrates an example avatar database that may be established and updated as new computer games with potentially new avatars are published. In the schematic representation shown, avatar images 200 are correlated to metadata 202 that may indicate the avatar name and the games in which the avatar appears, along with a hash value 204 of the image of the avatar. In an example embodiment, a perceptual hash is executed on the image of the avatar. The perceptual hash may be a p-hash. In a perceptual hash, an image is reduced to a relatively few pixels then hashed to establish bits, which can be compared to other image hashes, e.g., on a bit-to-bit basis with the shortest Hamming distance indicating which avatar is closest in appearance to the player's image. A perceptual hash thus is not a cryptographic hash such as MD-5 or SHA 256.

FIGS. 3-5 illustrate example user interfaces UI) that may be presented on a display such as the display 14 shown in FIG. 1 that in turn may be connected to a computer game console to also present demanded computer game images. A banner 300 may indicate that the user can personalize his or her avatar. Two methods are provided in FIG. 3. A first selector 302 may be selected to find, in the database of FIG. 2, an avatar that most closely resembles an image of the user. A second selector 304 may be selected to blend an image of the user with an image of an avatar to produce a morphed avatar, essentially a composite of the user and avatar images.

In the example shown, personalizing avatars may be monetized by, in a non-limiting example embodiment, presenting a cost 306 for personalizing the avatar and an accept selector 308 that, if selected, causes the executing processor to proceed with personalization as described further below and to identify that remuneration from the user to the game publisher or other entity is authorized. The user can decline to pay for the personalization by selecting an exit selector 310, in which case the process ends.

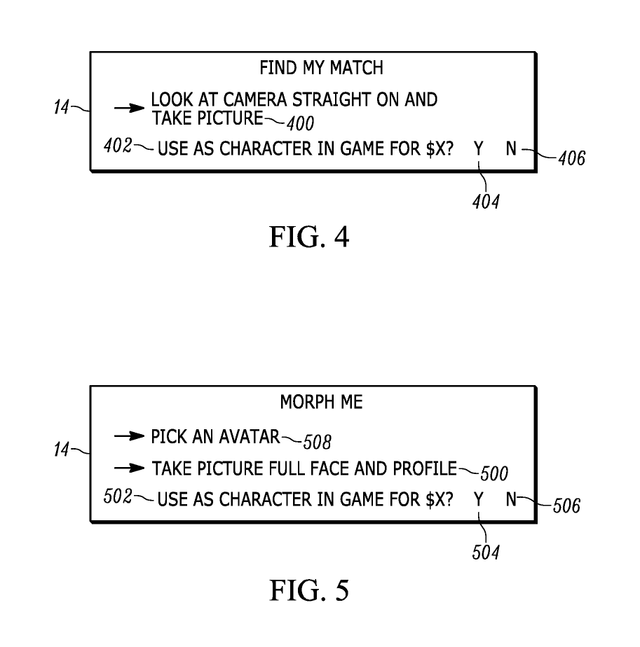

FIG. 4 indicates that the user has selected the selector 302 in FIG. 3 to find, in the database of FIG. 2, an avatar that most closely resembles an image of the user, causing the UI of FIG. 4 to be presented. A prompt 400 may be presented to instruct the user what kind of image to generate/input into the processor, in the example shown, a full-face image generated by looking straight at the imaging camera (which may be any of the cameras disclosed herein) and taking a picture of the user.

Additionally, further monetization may be realized by presenting a prompt 402 to give the user the choice of using the personalized avatar for an indicated price. The user may select to do so by selecting an accept selector 404. The user may decline to do so by selecting a decline selector 406.

FIG. 5 indicates that the user has selected the selector 304 in FIG. 3 to blend an image of the user with an image of an avatar to produce a morphed avatar, causing the UI of FIG. 5 to be presented. A prompt 500 may be presented to instruct the user what kind of image to generate/input into the processor, in the example shown, a full-face image generated by looking straight at the imaging camera (which may be any of the cameras disclosed herein) and a profile image. Other types of images prompted for may be full body images.

Additionally, further monetization may be realized by presenting a prompt 502 to give the user the choice of using the personalized avatar for an indicated price. The user may select to do so by selecting an accept selector 504. The user may decline to do so by selecting a decline selector 506. The user may also be presented with a prompt 508 to select the avatar with which the user's image is to be blended. Selection of the prompt 508 may cause a list of avatars and images to be presented from which the user may select an avatar.

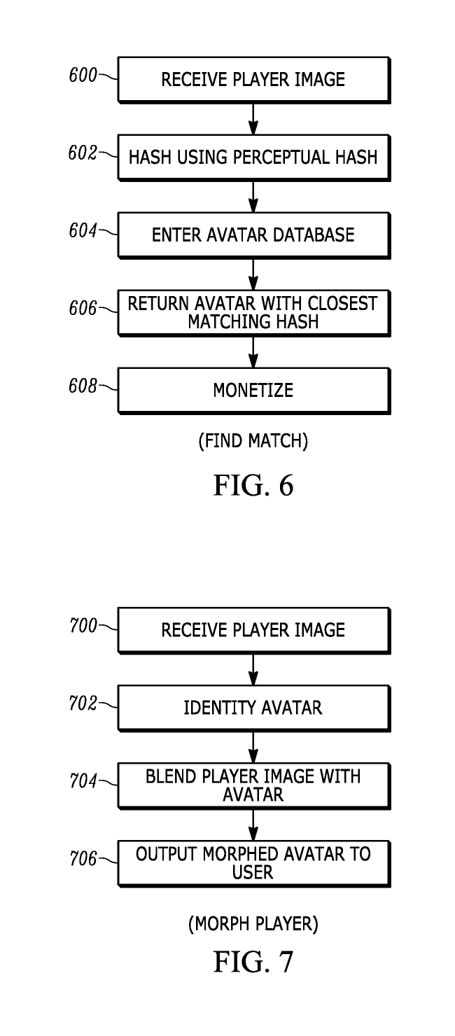

FIG. 6 illustrates example logic for finding a closest avatar in appearance to the user's image from FIG. 4. Commencing at block 60X), the user's image (referred to in FIG. 6 as a “player” on the assumption that the user will play a computer game) is received and at block 602 hashed using, e.g., a perceptual hash to render a hash result. The hash result is used at block 604 as entering argument to the avatar database of FIG. 2 and compared to the hashes in the database to find the closest avatar based on the hash in the database that is closest to the hash result of the user's image. The closest avatar is returned at block 606 as a personalized avatar for the user.

Monetization may be realized at block 608 according to the disclosure above. Furthermore, monetization may be realized by allowing, for a price, users to further customize their personalized avatars by selecting apparel for the avatar, eye/hair color for the avatar, etc. Monetization may be further realized by selling the user screen shots of his or her avatar and game scores.

FIG. 7 illustrates example logic for blending an avatar image with the user's image to produce a morphed avatar from FIG. 5. Commencing at block 600, an image of the user (“player”) is received. An avatar to blend is identified at block 702. This may be done by allowing the user to select an avatar from a list as mentioned above, or in some embodiments it may be done by executing the logic of FIG. 6 to find a closest avatar and use the closest avatar as the avatar to be blended with the user image.

Proceeding to block 704, the image of the avatar from block 702 is blended with the image of the user from block 700 to render a composite or “morphed” avatar. Blending may be accomplished using any appropriate bending algorithm such as but not limited the ones specifically disclosed herein. For example, blending the user and avatar images may be done using bitmaps and averaging corresponding bits to produce an average image, or using layer masks, or using alpha blending, in which a composite of two images is derived from combining pixel color values based on pixel transparency (alpha) values, typically on a pixel-by-pixel basis, etc. Blending may be of facial features only or it may be done by blending a full body image of the user with a full body image of the avatar.

It will be appreciated that whilst present principals have been described with reference to some example embodiments, these are not intended to be limiting, and that various alternative arrangements may be used to implement the subject matter claimed herein.

What is claimed is:

1. A device comprising:
at least one computer memory that is not a transitory signal and that comprises instructions executable by at least one processor to:
receive at least one image of at least one human user:
execute a perceptual hash on the image to render a hash result;
select from a data store of computer game avatars a closest avatar based at least in part on a hash associated with the closest avatar being a closest match to the hash result; and
return the closest avatar to a computer game device as an avatar associated with the human user.

2. The device of claim 1, wherein the perceptual hash is a p-hash.

3. The device of claim 1, wherein the instructions are executable to:
present on at least one display a prompt for the human user to enable the closest avatar to represent a character in a computer game; and
responsive to a selection to enable the closest avatar to represent a character in a computer game, identify at least one transaction for the user to remit remuneration.

4. The device of claim 1, wherein the instructions are executable to:
present on at least one display a prompt for the human user to input an image of the human user having a delineated characteristic for use in comparing to the avatars in the data store.

5. The device of claim 4, wherein the delineated characteristic is a full-face view.

6. The device of claim 4, wherein the delineated characteristic is a face and body view.

7. The device of claim 1, wherein the data store is updated with avatars of new computer games pursuant to the new computers games being published.

8. The device of claim 1, comprising the at least one processor.

9. An apparatus comprising:
at least one computer storage comprising instructions executable by at least one processor; and
at least one processor configured to access the instructions for:
receiving at least one image of at least one human user;
blending the image of the user with an image of an avatar of a computer game to render a morphed avatar, and
returning the morphed avatar to a computer game device as an avatar associated with the human user.

10. The apparatus of claim 9, wherein the instructions are executable to:
present on at least one display a prompt for the human user to enable the morphed avatar to represent a character in a computer game; and
responsive to a selection to enable the morphed avatar to represent a character in a computer game, identify at least one transaction for the user to remit remuneration.

11. The apparatus of claim 9, wherein the instructions are executable to:
present on at least one display a prompt for the human user to input an image of the human user having a delineated characteristic for use in rendering the morphed avatar.

12. The apparatus of claim 11, wherein the delineated characteristic is a full-face view.

13. The apparatus of claim 11, wherein the delineated characteristic is a face and body view.

14. The apparatus of claim 9, wherein the avatar of a computer game is stored in a data store of computer game avatars.

15. The apparatus of claim 14, wherein the data store is updated with avatars of new computer games pursuant to the new computers games being published.

16. The apparatus of claim 9, wherein the instructions are executable to:
present a prompt on a display to select the avatar of a computer game from a set of avatars.

17. A method, comprising:
receiving at least one image of at least one human; and
based at least in part on the image, returning an avatar for a computer game.

18. The method of claim 17, wherein returning the avatar comprises:
executing a hash of the image to render a hash result;
selecting from a data store of computer game avatars a closest avatar based at least in part on a hash associated with the closest avatar being a closest match to the hash result; and
returning the closest avatar to a computer game device as an avatar associated with the user.

19. The method of claim 17, wherein returning the avatar comprises:
blending the image with an avatar of a computer game to render a morphed avatar; and
returning the morphed avatar to a computer game device as an avatar associated with the user.

20. The method of claim 17, comprising monetizing the returning step.
